(19) United States
(12) Patent Application Publication
(10) Pub. No.: US 2020/0279977 A1
(43) Pub. Date: Sep. 3, 2020

(54) LIGHT CONVERSION DEVICE WITH ENHANCED INORGANIC BINDER

(71) Applicant: MATERION PRECISION OPTICS (SHANGHAI) LIMITED, Shanghai (CN)

(72) Inventors: Wenbo Zhang, Shanghai (CN); Ying Xu, Shanghai (CN); Qiming Li, Shanghai (CN)

(21) Appl. No.: 16/645,950

(22) PCT Filed: Sep. 20, 2017
(86) PCT No.: PCT/CN2017/102465

§ 371 Date: Mar. 10, 2020

(51) Int. Cl. H01L 33/50; C09K 11/02

(52) U.S. Cl. CPC H01L 33/501; C09K 11/02

(57) ABSTRACT

A light conversion device comprising a layer formed from an inorganic binder, the inorganic binder comprising: from about 25 to about 80 wt % of a filler; from about 20 to about 75 wt % of an inorganic adhesive; and from about 0.5 to about 5 wt % of a dispersant. The inorganic binders are capable of withstanding high temperatures, have a high light transmittance, have a high tensile-shear strength, can be applied by a flexible coating process, and have a low curing temperature. Such inorganic binders could advantageously be employed in a variety of applications, such light tunnels (300), projection display systems, and optical light conversion devices, such as phosphor wheels (100), used in such systems.

### BACKGROUND

The present disclosure relates to inorganic binders that possess certain characteristics that make them particularly suitable for use in projection display systems and optical light conversion devices, such as phosphor wheels, used in such systems. In particular, the inorganic binders of the present disclosure maintain an enhanced bonding strength at temperatures up to 400° C.

Organic adhesive (e.g., epoxy, polyurethane, silicone) is widely used for bonding. For example, in a phosphor-in-silicone product, phosphor powder is mixed into a silicone binder or adhesive, then dispensed or printed in the desired pattern. Silicone is popular for the bonding of metal, glass, and other materials due to its high transparency, high bonding strength, lower refractive index, and proper viscosity. For example, a popular binder choice is Dow Corning® OE-6336, a silicone adhesive manufactured by Dow Corning®, which has a mixed viscosity of 1,425 centipoise (cP), a transparency of 99.6% at 450 nm and 1 mm thickness, a refractive index of 1.4, and a heat curing time of 60 minutes at 150° C.

However, silicone binders/adhesives have poor thermal stability. At temperatures over 200° C., silicone adhesives will degrade, typically begin to turn yellow, and gradually begin to burn. This undesirably leads to a short service lifetime for the phosphor wheel, and the light conversion efficiency has been observed to drop sharply (>10% @ 200° C.) due to thermal quenching. In applications with high brightness (e.g., laser power of 300 W), the operating temperature of the phosphor wheel is expected to be generally more than 200° C., thus making the use of silicone adhesive undesirable. That is, a phosphor-in-silicone product cannot achieve a long operational life in high-power laser projectors. In lifetime tests for such a product, it was established that the safe working temperature should be controlled under 150° C.

It would therefore be desirable to provide an inorganic binder that exhibits the same desirable characteristics of organic binders (i.e., high transparency, high bonding strength, low refractive index, and proper viscosity), in addition to a higher temperature resistance (e.g., more than 200° C., including 300° C. or more, and up to 400° C.). Such inorganic binders could advantageously be employed in a variety of applications, such light tunnels, projection display systems, and optical light conversion devices, such as phosphor wheels, used in such systems.

### BRIEF DESCRIPTION

The present disclosure relates to inorganic binders that can be used in high reflectivity coatings for an optical light conversion device (e.g., a phosphor wheel) or as an adhesive used to join two elements. The inorganic binders possess certain characteristics that make them particularly suitable for use in high-power lighting systems. For example, in particular embodiments, the inorganic binders are capable of withstanding high temperatures (e.g., greater than 200° C., including 300° C. or more, and up to 400° C.), have a high light transmittance (e.g., at least 98%), have a high tensile-shear strength (e.g., at least 100 psi at 300° C.), can be applied by a flexible coating process (e.g., dispensing, silk printing, spraying), and have a low curing temperature (e.g., less than 185° C.).

In certain constructions, the compositions consist essentially of: from about 25 to about 80 wt % of one or more fillers; from about 20 to about 75 wt % of one or more inorganic adhesives; and from about 0.5 to about 5 wt % of one or more dispersants.

The inorganic adhesive can include a first component (e.g., a semitransparent liquid) and a second component (e.g., a transparent liquid). A ratio of the first component to the second component can be from about 1:1 to about 7:3. The inorganic adhesive can be prepared by stirring the first and second components. The first and second components can be stirred for a period of from about 2 hours to about 3 hours. The first and second components can be stirred at a temperature of from about 25° C. to about 30° C. In particular embodiments, the first component has a viscosity of from about 1 mPa·sec to about 50 mPa·sec, a density of from about 0.8 g/cm³ to about 1.3 g/cm³, and a solids content of more than 10%. In some embodiments, the second component has a viscosity from 0 mPa·sec to about 50 mPa·sec, a density of from about 0.6 g/cm³ to about 1.0 g/cm³, and a solids content of more than 10%.

In certain constructions, a thermal expansion coefficient of the filler is within 20% of (±20%) a thermal expansion coefficient of the inorganic adhesive. A density of the filler can also be within 20% of (±20%) a density of the inorganic adhesive.

The filler(s) can be selected from the group consisting of silica, aluminum oxide, and borazon. The filler can have a granular, flaky, or fibrous shape. The filler can have a particle size of from about 0.1 to about 50 microns.

In some embodiments, the dispersant is organic (e.g., polyvinylpyrrolidone, polyacrylate, gelatin, polyvinyl alcohol, cellulose, styrene-co-maleic anhydride, or lignosulfate). In alternative embodiments, the dispersant is inorganic (e.g., hexametaphosphate, silicate, polyphosphate, or fumed silica).

A method of forming an inorganic binder according to the present disclosure comprises: performing a first curing at a temperature of from about 60° C. to about 90° C. for a period of from about 0.2 hours to about 1 hour, and subsequently performing a second curing at a temperature of from about 150° C. to about 200° C. for a period of from about 0.4 hours to about 2 hours.

Also disclosed herein are light conversions devices comprising: a substrate having an inorganic coating, the inorganic coating comprising: from about 20 to about 80 wt % of a filler; from about 20 to about 75 wt % of inorganic adhesive; and from about 0.5 to about 5 wt % of a dispersant. In more specific embodiments, the filler is present in the amount of about 60 to about 75 wt %, and the inorganic adhesive is present in the amount of about 20 to about 35 wt %.

The substrate can be in the form of a disk. The light conversion device can further comprise a motor arranged to rotate the substrate around an axis normal to the substrate.

In some embodiments, the filler is a phosphor (e.g., yttrium aluminum garnet, silicate, or nitride). The phosphor can have a particle size of from about 10 to about 30 microns.

In particular embodiments, the filler is a refractive powder having a particle size of from about 0.1 micron to about 150 microns. The resulting inorganic coating can have a high reflectivity (e.g. at least 80%, at least 90%, at least 95%, at least 98%, etc.) for light having a wavelength from about 380 nm to about 800 nm. The light conversion device can further comprise a phosphor layer applied over the inorganic coating on the substrate.

A method of forming a light conversion device according to the present disclosure comprises: applying the inorganic coating to the substrate by spraying, dispensing, or silk printing; performing a first curing of the inorganic coating at a temperature of about 85° C. for a period of about 0.25 hours, and subsequently performing a second curing of the inorganic coating at a temperature of about 185° C. for a period of about 0.75 hours.

Further disclosed herein are light tunnels comprising: a plurality of reflectors joined together by an inorganic adhesive capable of withstanding temperatures greater than 200° C., the inorganic adhesive comprising: from about 25 to about 80 wt % of a filler; from about 20 to about 75 wt % of an inorganic adhesive; and from about 0.5 to about 5 wt % of a dispersant.

In particular embodiments, the filler can be aluminum oxide. The filler can have a particle size of from about 0.5 microns to about 10 microns.

A method of forming a light tunnel according to the present disclosure comprises: performing a first curing of the inorganic adhesive at a temperature of about 85° C. for a period of about 0.25 hours, and subsequently performing a second curing of the inorganic adhesive at a temperature of about 185° C. for a period of about 0.75 hours.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1A is a schematic illustration of a first exemplary optical light conversion device according to the present disclosure including a substrate and a coating.

FIG. 1B is a side cross-sectional view of the first exemplary optical light conversion device of FIG. 1A.

FIG. 2A is a schematic illustration of a second exemplary optical light conversion device according to the present disclosure including a substrate, a high-reflectivity scattering layer, and a phosphor layer.

FIG. 2B is a side cross-sectional view of the second exemplary optical light conversion device of FIG. 2A.

FIG. 3 is a schematic illustration of a light tunnel according to the present disclosure including a plurality of reflectors joined together by an adhesive.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

As used herein, the terms “excitation light” and “excitation wavelength” refer to input light which is subsequently converted, e.g. light produced by a laser-based illumination source or other light source. The terms “emission light” and “emission wavelength” refer to the converted light, e.g. the resulting light produced by a phosphor which has been exposed to excitation light.

As used herein, the term “inorganic” means the “inorganic” object does not contain any carbon. For avoidance of doubt, the terms “inorganic binder,” “inorganic adhesive,” “inorganic coating,” and “inorganic adhesive” of the present disclosure do not contain carbon.

For reference, the color red usually refers to light having a wavelength of about 780 nanometers to about 622 nanometers. The color green usually refers to light having a wavelength of about 577 nanometers to about 492 nanometers. The color blue usually refers to light having a wavelength of about 492 nanometers to about 455 nanometers. The color yellow usually refers to light having a wavelength of about 597 nanometers to about 577 nanometers. However, this may depend on the context. For example, these colors are sometimes used to label various parts and distinguish those parts from each other.

The present disclosure relates to inorganic binders that possess certain characteristics that make them particularly suitable for use in high-power lighting systems. The inorganic binders are compositions containing multiple ingredients. Some performance characteristics such as conversion light output, color, and lifetime are direct functions of working temperature. At higher operating temperatures, the conversion light output may decrease, the color may shift, and the operating lifetime may be decreased. Under normal operating conditions, approximately 50%-60% of the input power is output as heat, while the rest of the input power is converted to light. At high input powers, heat generation during the conversion will cause high sustained temperatures of more than 200 degrees Celsius (200° C.), including 300° C. or more, and up to 400° C.

In particular embodiments, the inorganic binders of the present disclosure are capable of withstanding high temperatures (e.g., greater than 200° C., including 300° C. or more, and up to 400° C.), have a high light transmittance (e.g., at least 98%), have a high tensile-shear strength (e.g., at least 100 psi at 300° C.), can be applied by a flexible coating process (e.g., dispensing, silk printing, spraying), and have a low curing temperature (e.g., less than 185° C.).

The inorganic binders of the present disclosure can be used in high-power lighting systems, such as an optical light conversion device (e.g., a phosphor wheel). The inorganic binders can be used in different layers to provide high reflectivity, or provide a wavelength conversion layer.

Very generally, as described in various embodiments herein, the inorganic binder comprises or consists essentially of: at least one filler, at least one inorganic adhesive, and at least one dispersant.

The inorganic binder may comprise from about 25 wt % to about 80 wt % of the filler, including from about 60 wt % to about 75 wt %, or from about 65 wt % to about 75 wt % of the filler, based on the weight of the inorganic binder. The filler can be used to obtain the desired function of the layer that is made from the inorganic binder. For example, the filler can be a phosphor to produce a wavelength conversion layer; or can be a refractive powder to produce a reflective coating. One or more different fillers can be present.

The inorganic binder may comprise from about 20 wt % to about 75 wt % of the inorganic adhesive, including from about 20 wt % to about 45 wt %, or from about 25 wt % to about 40 wt % of the inorganic adhesive, based on the weight of the inorganic binder.

The inorganic binder may comprise from about 0.5 wt % to about 5 wt % of the dispersant, including from about 1 wt % to about 4 wt %, or from about 2 wt % to about 3 wt % of the dispersant, based on the weight of the inorganic binder. One or more dispersants can be used, and these amounts are applied to all dispersants combined.

In specific embodiments, the inorganic binder consists essentially of from about 25 to about 80 wt % of one or more fillers, from about 20 to about 75 wt % of one or more inorganic adhesives, and from about 0.5 to about 5 wt % of one or more dispersants, with the total of these ingredients being 100 wt %.

In other particular embodiments, the inorganic binder consists essentially of from about 60 to about 75 wt % of one or more fillers, from about 20 to about 40 wt % of one or more inorganic adhesives, and from about 0.5 to about 5 wt % of one or more dispersants, with the total of these ingredients being 100 wt %.

The addition of the filler(s) to the inorganic adhesive(s) enhances the bonding strength of the inorganic binder. In particular, the addition of the filler(s) can reduce the shrinkage rate of the inorganic binder, reducing or preventing the formation of bubbles or cracks during solidification, thereby decreasing the amount and/or effect of stress during use and improving the bonding strength of the inorganic binder. The filler(s) can be chosen to have a thermal expansion coefficient that is within 20% of the thermal expansion coefficient of the inorganic adhesive. Similarly, to avoid stratification, the filler(s) can be chosen to have a density that is within 20% of the density of the inorganic adhesive. The filler(s) may have any desired shape, such as a granular, flaky, or fibrous shape. Any suitable filler(s) can be used. For example, it is specifically contemplated that that the filler(s) could be silica, a silicate, an aluminate, or a phosphate, or diamond powder. The filler could be a metal powder, such as aluminum, copper, silver, or gold powder. The filler could be a nitride, such as aluminum nitride or borazon. The filler could be an oxide, such as aluminum oxide or boron oxide. The filler could be a metallic oxide, metal nitride, or metal sulfide. The filler(s) can be of any suitable particle size, such as from about 0.1 micron to about 50 microns.

The addition of the dispersant(s) is beneficial to disperse the filler(s) throughout the binder, thereby avoiding undesirable aggregation or sedimentation. Any suitable dispersant(s) can be used. For example, it is specifically contemplated that the dispersant(s) could be an organic dispersant, such as polyvinylpyrrolidone, polyacrylate, gelatin, polyvinyl alcohol, cellulose, styrene-co-maleic anhydride, or lignosulfate. It is specifically contemplated that, alternatively, the dispersant(s) could be an inorganic dispersant, such as hexametaphosphate, silicate, polyphosphate, or fumed silica.

As previously explained, the inorganic binder can be employed in a variety of applications, such as a coating to form one or more layers within an optical light conversion device, such as a phosphor wheel. A phosphor wheel is used to generate light of different colors sequentially. Light conversion (or wavelength conversion) materials such as phosphors are used on the phosphor wheel. The phosphor wheel normally has some fan segments which contain different types of phosphor to convert the excitation light to a green, yellow, or red color. Typically, a blue light laser (having a wavelength of about 440 nm to about 460 nm) is used to excite the phosphor segments on the phosphor wheel. The phosphor wheel can also have one or more gaps to pass the blue source light through unconverted.

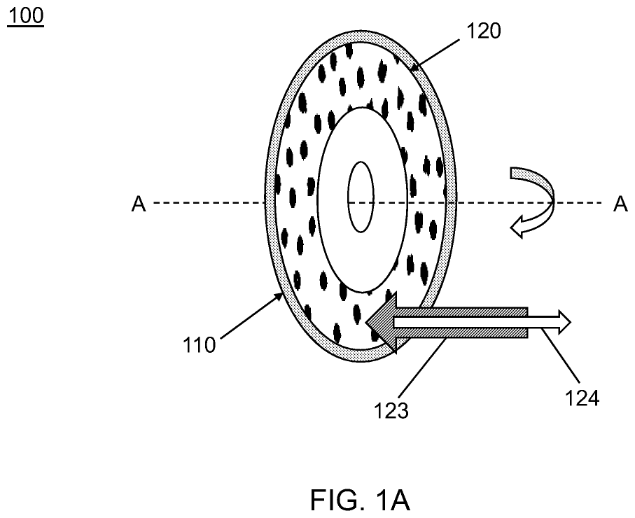

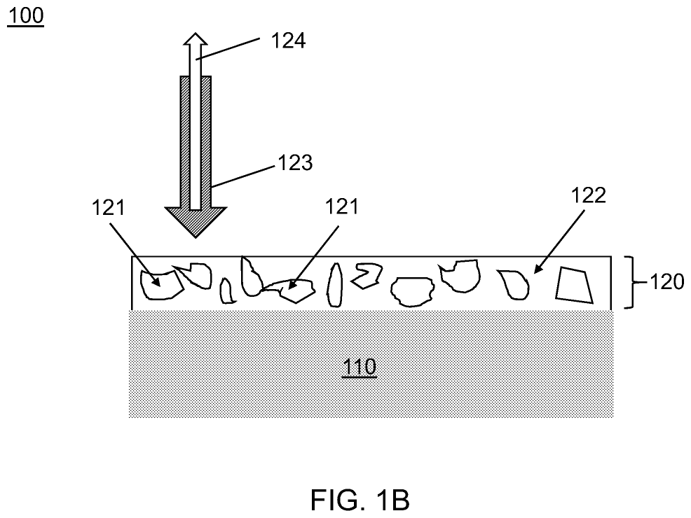

FIG. 1A and FIG. 1B illustrate such a light conversion device including a wavelength conversion layer formed from the inorganic binder. In particular, the first exemplary light conversion device is a phosphor wheel 100. FIG. 1A is a schematic illustration of phosphor wheel 100, and FIG. 1B is a side cross-sectional view of phosphor wheel 100. Phosphor wheel 100 includes a substrate 110 onto which the inorganic binder is applied to form the wavelength conversion layer 120. The wavelength conversion layer is an inorganic coating that consists essentially of filler 121, inorganic adhesive 122, and dispersant (not shown). In this particular embodiment, the wavelength conversion layer consists essentially of: from about 60 to about 75 wt % of the filler, from about 20 to about 45 wt % of the inorganic adhesive, and from about 0.5 to about 5 wt % of the dispersant.

The substrate 110 is typically a metal having a high thermal conductivity, e.g. aluminum or an aluminum alloy, copper or a copper alloy, or another metal having a high thermal conductivity. The substrate could also, for example, be made of glass, sapphire, or diamond. For illustrative purposes, the wavelength conversion layer 120 is shown apart from the substrate 110, though, in use, the inorganic binder is applied directly to the substrate 110 by, for example, spraying, dispensing, or silk printing, to form the wavelength conversion layer.

In this exemplary embodiment of phosphor wheel 100, the filler is a phosphor. Suitable phosphors include yttrium aluminum garnet (YAG), silicate, and nitride. The phosphors can have a particle size of from about 10 to about 30 microns. The phosphor filler, along with the dispersant, can then be combined with the inorganic adhesive (e.g., a liquid transparent inorganic adhesive) to form the inorganic binder. The inorganic binder can be dispersed, sprayed, or silk printed onto the substrate, and then thermally cured and solidified to form the wavelength conversion layer 120, such as in a concentric pattern when the substrate 110 is in the shape of a disk. The curing of the inorganic coating 120 can be performed in a step-by-step process. For example, in this exemplary embodiment, a first curing step is performed at a temperature of about 75° C. to about 100° C. for a period of about 0.1 hours to about 1 hour, e.g. 0.25 hours. The second curing step is subsequently performed at a higher temperature of about 150° C. to about 200° C. for a period of about 0.5 hours to about 1 hour.

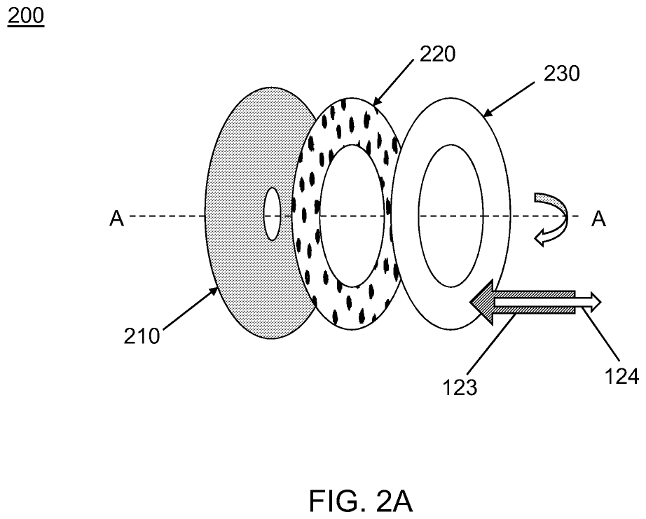

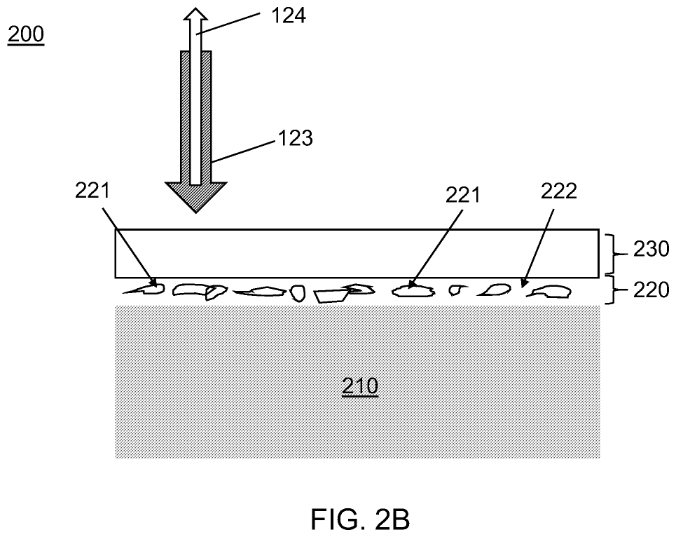

Turning now to FIG. 2A and FIG. 2B, another optical light conversion device is depicted. In particular, the second exemplary light conversion device is another phosphor wheel 200. FIG. 2A is a schematic illustration of phosphor wheel 200, and FIG. 2B is a side cross-sectional view of phosphor wheel 200. Phosphor wheel 200 includes a substrate 210 onto which the inorganic binder is applied to form a reflective layer 220, with a phosphor layer 230 applied over the reflective layer 220 on the substrate 210. The inorganic coating comprises a filler 221, an inorganic adhesive 222, and a dispersant (not shown). In particular, in this exemplary embodiment of phosphor wheel 200, the inorganic coating consists essentially of: from about 65 to about 75 wt % of the filler, from about 20 to about 35 wt % of the inorganic adhesive(s), and from about 1 wt % to about 2 wt % of the dispersant(s).

In this embodiment of phosphor wheel 200, the filler(s) includes one or more refractive powders. The refractive powder(s) can have a particle size of from about 0.1 micron to about 150 microns. The refractive powder(s), along with the dispersant(s), can then be combined with the inorganic adhesive(s) (e.g., a liquid transparent inorganic adhesive) to form the inorganic binder. The inorganic binder can then be dispersed, sprayed, or silk printed onto the substrate, and then thermally cured and solidified on the substrate 210, such as in a concentric pattern when the substrate 210 is in the shape of a disk, to prepare a substrate 210 with a high-reflectivity layer 220 thereon. For example, the inorganic coating 220 can have high reflectivity of light having a wavelength from about 380 nm to about 800 nm. The curing of the inorganic binder can be performed in a step-by-step process. For example, in this exemplary embodiment, a first curing step is performed at a temperature of about 75° C. to about 100° C. for a period of about 0.1 hours to about 1 hour, e.g. 0.25 hours. The second curing step is subsequently performed at a temperature of about 150° to about 200° C., e.g. 185° C., for a period of about 0.5 hours to about 1 hour, e.g. 0.75 hours.

Phosphor wheel 200 further includes a phosphor layer 230 (e.g., a layer of phosphor powder) applied over the high reflectivity layer 220 on the substrate 210. The phosphor layer 200 can be applied by, for example, dispensing or silk printing.

Phosphor wheel 100 of FIG. 1A and FIG. 1B and phosphor wheel 200 of FIG. 2A and FIG. 2B can both be created by mounting the substrate on a motor to rotate with high speed. Typically, the substrate is rotated during use, although this device can be used in a static (non-rotating) configuration, in which case it may not be known as a phosphor wheel. Rotation of the phosphor wheel is depicted in FIG. 1A and FIG. 2A by the arrow rotating around axis A-A passing through each substrate 110, 210 and normal to the planar surface of each substrate 110, 210.

As seen in FIG. 1A-1B and FIG. 2A-2B, excitation light 123 of an excitation wavelength (i.e., exciting or input light) from a light source (not shown) (e.g., a laser-based illumination source) is focused on the inorganic coating, emission light 124 of an excitation wavelength (i.e., emitted or converted light) is generated by the inorganic coating. In this way, the inorganic coating converts the light spectrum from excitation light of a first range of spectral wavelengths to emission (or re-emission) light of a second, different range of spectral wavelengths. When the light of the excitation wavelength 123 (e.g., laser beam blue light) focuses on the inorganic coating, the light of the emission wavelength 124 (e.g., yellow light) will emit and will be reflected by the inorganic coating, and can then be collected, for example by a lens. The phosphor wheels can be made with an inorganic coating including multiple color segments (not shown here), each of which is used to generate light with a particular color, or can be made to emit light of any desired color. For example, the inorganic coating may be configured to absorb blue light and/or generate yellow light and/or green light.

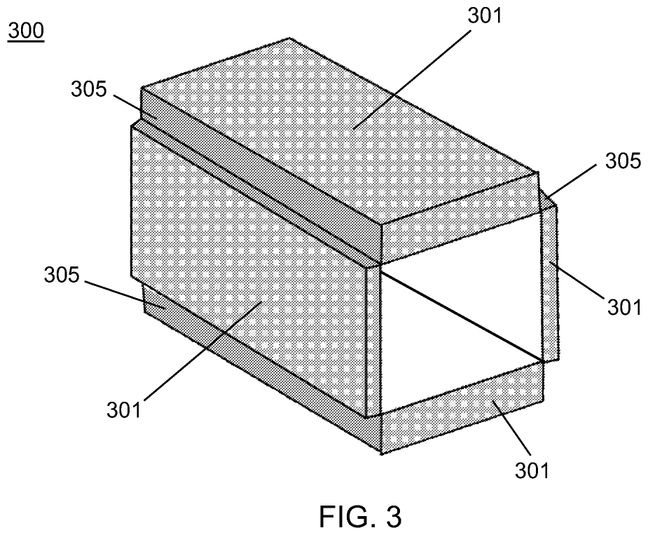

With reference now to FIG. 3, an exemplary light tunnel employing an inorganic binder as an adhesive is depicted. Light tunnel wheel 300 includes a plurality of reflectors 301 arranged so as to define a hollow tunnel therebetween. An inorganic binder 305 is applied to join the reflectors together. The inorganic binder comprises one or more fillers, one or more inorganic adhesives, and one or more dispersants. In particular, in this exemplary embodiment of light tunnel 300, the inorganic binder consists essentially of: from about 60 to about 75 wt % of the filler(s), from about 20 to about 45 wt % of the inorganic adhesive(s), and from about 2 wt % to about 3 wt % of the dispersant(s).

In this exemplary embodiment of light tunnel 300, the filler is aluminum oxide (Al₂O₃). The aluminum oxide filler can have a particle size of from about 0.5 to about 10 microns. The aluminum oxide filler, along with the dispersant(s), can then be combined with the inorganic adhesive(s) (e.g., a liquid transparent inorganic adhesive) to form the inorganic binder 305. The inorganic binder 305 can then be dispensed at the junctions between adjacent reflectors 301 for joining the same. The inorganic binder 305 is then thermally cured and solidified. The curing of the inorganic binder 305 can be performed in a step-by-step process. For example, in this exemplary embodiment, a first curing step is performed at a temperature of about 85° C. for a period of about 0.25 hours. The second curing step is subsequently performed at a temperature of about 185° C. for a period of about 0.75 hours.

The inorganic binders/inorganic binder coatings and adhesives of the present disclosure provide many advantages over traditional phosphor-in-silicone light converters. For example, a phosphor-in-inorganic adhesive coating can maintain light conversion efficiency at temperatures up to at least 200° C., including 300° C. or more, and up to 400° C. The coating should have high transparency at visible wavelengths; a low refractive index; high bonding strength; high thermal stability (i.e. a high Tg or maximum operating temperature); a relatively low curing/sintering temperature; good compatibility/miscibility with the phosphor; and/or desirable viscosity. This will enhance the thermal endurance of a phosphor wheel at temperatures from 165° C. up to 400° C.

Desirably, the inorganic binder is substantially optically transparent (e.g., the inorganic binder has a light transmittance of at least 80%, at least 90%, at least 95%, or at least 98%. This is measured, for example, by using a Lambda 950 spectrophotometer available from Perkin-Elmer. In contrast, many organic binders are opaque. This permits the inorganic binder to be used in a transmissive or reflective phosphor wheel.

The inorganic binders can exhibit a greater bonding strength than conventional silicone adhesives. In particular embodiments, the inorganic binder of the present disclosure can have an initial bonding strength of at least 100 psi, or at least 200 psi, or from about 100 psi to about 600 psi. This property is measured using two aluminum test plates with the inorganic binder placed between the two plates at a thickness of 0.1 mm and a bonding area of 169 square mm, at the maximum temperature at which the adhesive is applied, for example at 300° C.

It has been found that inorganic adhesives are usually long-term stable and therefore performance of these devices does not necessarily degrade significantly over time. Moreover, organic materials can exhibit some outgassing at high working temperatures. This may result in contamination of nearby components in an optical device. Additionally, inorganic binders may be more durable than traditional silicone materials in high power conditions. They exhibit reliable operation under high laser irradiance and temperature. They can also be flexibly made into various sizes, shapes, and thicknesses. The inorganic binders of the present disclosure are also capable of withstanding high working temperatures, namely working temperatures in excess of 200° C. They can be used in high-power laser projection display systems where the solid-state laser projector can be equipped with laser power from about 60 watts to about 300 watts, including in excess of 100 watts. The working temperature of such devices can reach above 200° C., including above 300° C., and up to 400° C., to enable high luminous brightness.

It is contemplated that the inorganic binders can be used in phosphor wheels and in laser projection display systems. They can also be used in conjunction with a solid-state illumination source, for example in automotive headlights. They can further be used as adhesives for light tunnels, light funnels, and the like.

The following examples are provided to illustrate the processes of the present disclosure. The examples are merely illustrative and are not necessarily intended to limit the disclosure to the materials, conditions, or process parameters set forth therein.

### EXAMPLES

### Example 1

In one exemplary embodiment, the inorganic adhesive(s) was formed from first and second components. The total dissolved solids (TDS) characteristics of the inorganic adhesive used is provided in the following table:

| | | Viscosity | Density | Solids |
|---|---|---|---|---|
| Designation | Appearance | (mPa · sec) | (g/cm³) | content |
| First Component | Semitransparent | 1~50 | 0.8~1.3 | >10% |
| | liquid | | | |
| Second Component | Transparent liquid | 0~50 | 0.6~1.0 | >10% |

The inorganic adhesive was prepared by mixing the first component and the second component and stirring for a period of about 2 to about 3 hours at a temperature of from about 25 to about 30° C. The ratio of the first component to the second component was from about 1:1 to about 7:3.

The inorganic binder was then prepared by adding the filler(s) and dispersant(s) to the inorganic adhesive(s). The inorganic binder was cured in a step-by-step process. The first curing step was performed at a temperature of from about 60 to about 90° C. for a period of from about 0.2 to about 1 hour. The second curing step was subsequently performed at a temperature of from about 150 to about 200° C. for a period of from about 0.4 to about 2 hours. The cured inorganic binder was shown to exhibit excellent bonding strength at max applied temperature due to the high temperature resistance of the inorganic binder.

The present disclosure has been described with reference to preferred embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A light conversion device comprising a layer formed from an inorganic binder, the inorganic binder comprising:
from about 25 to about 80 wt % of a filler;
from about 20 to about 75 wt % of an inorganic adhesive; and
from about 0.5 to about 5 wt % of a dispersant.

2. The light conversion device of claim 1, wherein the inorganic adhesive is made from a first component and a second component, wherein a ratio of the first component to the second component is from about 1:1 to about 7:3.

3. The light conversion device of claim 2, wherein the in organic adhesive prepared by stirring the first and second components for a period of from about 2 hours to about 3 hours at a temperature of from about 25 to about 30° C.

4. The light conversion device of claim 2, wherein the first component is a semitransparent liquid and the second component is a transparent liquid.

5. The light conversion device of claim 1, wherein:
the first component has a viscosity of from about 1 to about 50 mPa·sec, a density of from about 0.8 to about 1.3 g/cm³, and a solids content of more than 10%; and
the second component has a viscosity of from about 0 to about 50 mPa·sec, a density of from about 0.6 to about 1.0 g/cm³, and a solids content of more than 10%.

6. The light conversion device of claim 1, wherein a thermal expansion coefficient of the filler is within 20% of a thermal expansion coefficient of the inorganic adhesive, and wherein a density of the filler is within 20% of a density of the inorganic adhesive.

7. The light conversion device of claim 1, wherein the filler is selected from the group consisting of a silicate, an aluminate, a phosphate, diamond powder, a metal powder, a nitride, an oxide, and a metal sulfide; and wherein the filler has a granular, flaky, or fibrous shape, and a particle size of from about 0.1 microns to about 50 microns.

8. The light conversion device of claim 1, wherein:
the dispersant is an organic dispersant selected from the group consisting of polyvinylpyrrolidone, polyacrylate, gelatin, polyvinyl alcohol, cellulose, styrene-co-maleic anhydride, and lignosulfate; or
the dispersant is an inorganic dispersant selected from the group consisting of hexametaphosphate, silicate, polyphosphate, and fumed silica.

9. The light conversion device of claim 1, wherein the inorganic binder is capable of withstanding temperatures greater than 200° C., has a light transmittance of at least 98%, and has a high tensile-shear strength of at least 100 psi at 300° C.

10. A method of forming the layer of the light conversion device of claim 1, the method comprising:
performing a first curing at a temperature of from about 60° C. to about 90° C. for a period of from about 0.2 hours to about 1 hour; and
subsequently performing a second curing at a temperature of from about 150° C. to about 200° C. for a period of from about 0.4 hours to about 2 hours.

11. A light conversion device, comprising:
a substrate; and
an inorganic coating upon the substrate, the inorganic coating comprising:
from about 25 to about 80 wt % of a filler;
from about 20 to about 75 wt % of an inorganic adhesive; and
from about 0.5 to about 5 wt % of a dispersant.

12. The light conversion device of claim 11, wherein the substrate is in the shape of a disk, and further comprising a motor arranged to rotate the substrate around an axis normal to the substrate.

13. The light conversion device of claim 11, wherein the filler is a phosphor selected from the group consisting of yttrium aluminum garnet, silicate, and nitride; and wherein the phosphor has a particle size of from about 10 microns to about 30 microns.

14. The light conversion device of claim 11, wherein the filler is a refractive powder having a particle size of from about 0.1 micron to about 150 microns.

15. The light conversion device of claim 14, wherein the inorganic coating has at least 80% reflectivity for light having a wavelength from about 380 nm to about 800 nm.

16. The light conversion device of claim 14, further comprising a phosphor layer applied over the inorganic coating on the substrate.

17. A method of forming the light conversion device of claim 11, the method comprising:
applying the inorganic coating to the substrate;
performing a first curing of the inorganic coating at a temperature of about 85° C. for a period of about 0.25 hours; and
subsequently performing a second curing of the inorganic coating at a temperature of about 185° C. for a period of about 0.75 hours.

18. A light tunnel, comprising:
a plurality of reflectors joined together by an inorganic binder capable of withstanding temperatures greater than 200° C., the inorganic binder comprising:
from about 25 to about 80 wt % of a filler;
from about 20 to about 75 wt % of an inorganic adhesive; and
from about 0.5 to about 5 wt % of a dispersant.

19. The light tunnel of claim 18, wherein the filler is aluminum oxide having a particle size of from about 0.5 microns to about 10 microns.

20. A method of forming the light tunnel of claim 18, the method comprising:
performing a first curing of the inorganic binder at a temperature of about 85° C. for a period of about 0.25 hours; and
subsequently performing a second curing of the inorganic binder at a temperature of about 185° C. for a period of about 0.75 hours.
